(19) United States
(12) Patent Application Publication
(10) Pub. No.: US 2012/0023951 A1
(43) Pub. Date: Feb. 2, 2012

(54) FUEL NOZZLE WITH AIR ADMISSION SHROUD

(76) Inventors: Nishant Govindbhai PARSANIA, Bangalore (IN); Gregory Boardman, Greenville, SC (US); Dheeraj Sharma, Bangalore (IN)

(21) Appl. No.: 12/845,986

(22) Filed: Jul. 29, 2010

(51) Int. Cl. F02C 7/22

(52) U.S. Cl. 60/748

(57) ABSTRACT

A fuel nozzle for a turbine engine includes an air admission shroud which admits a flow of air from an exterior of the fuel nozzle into an interior of the fuel nozzle at a position along the length of the fuel nozzle. A plurality of air admission apertures in the air admission shroud could be arranged to cause the air being admitted into the interior of the fuel nozzle to swirl around the interior of the fuel nozzle in a rotational fashion. If the fuel nozzle also includes swirler vanes located upstream of the air admission shroud, which also induce air within the fuel nozzle to swirl around the interior of the fuel nozzle in a rotational fashion, then the air admission apertures of the air admission shroud preferably cause the air admitted through the air admission shroud to swirl in a rotational direction which is opposite to the swirl induced by the swirler vanes. This helps to better mix the air and the fuel within the nozzle.

### BACKGROUND OF THE INVENTION

Turbine engines used in the power generation industry typically utilize a plurality of combustors which are arranged in a concentric ring around the exterior of the compressor section of the turbine. Within each combustor, a plurality of fuel nozzles deliver fuel into a flow of compressed air. The air-fuel mixture is then ignited within the combustor, and the hot combustion gases are directed to the turbine section of the engine.

In many fuel nozzles, compressed air runs down the inside of the nozzle body, and fuel is added to the air while it is inside the nozzle. Some fuel nozzles also include swirler vanes which are arranged inside the nozzle body. The swirler vanes cause the air passing down the length of the interior of the fuel nozzle to swirl around the interior of the nozzle in a rotational fashion. This swirling movement helps to mix the fuel and the air, and this mixing or pre-mixing helps to prevent the generation of undesirable combustion byproducts such as NOₓ.

### BRIEF DESCRIPTION OF THE INVENTION

In a first aspect, the invention may be embodied in a fuel nozzle for a combustor of a turbine engine that includes an outer housing, and an air admission shroud that is located at an intermediate point along a length of the outer housing. The air admission shroud includes a plurality of air admission apertures that allow air passing along an exterior of the outer housing to enter an interior of the outer housing.

In another aspect, the invention may be embodied in a fuel nozzle for a combustor of a turbine engine that includes an outer housing, an inner fuel passageway located at approximately the center of the outer housing, and a plurality of swirler vanes that are located in an annular space between an outer surface of the inner fuel passageway and an inner surface of the outer housing. The swirler vanes cause air passing down the annular space to swirl in a first rotational direction around the annular space. The fuel nozzle also includes an air admission shroud that is located at an intermediate point along a length of the outer housing, wherein the air admission shroud includes a plurality of air admission apertures that allow air passing along an exterior of the outer housing to enter the annular space at a location downstream of the swirler vanes.

### BRIEF DESCRIPTION OF THE DRAWINGS

FIG. 1 is a longitudinal cross-sectional view of a portion of a fuel nozzle;

FIG. 2 is a transverse cross-sectional view of the fuel nozzle illustrated in FIG. 1;

FIG. 3 is a partial cross sectional view of a portion of the fuel nozzle illustrated in FIG. 1; and

FIG. 4 is a cross sectional view illustrating an air admission shroud insert for a fuel nozzle.

### DETAILED DESCRIPTION OF THE INVENTION

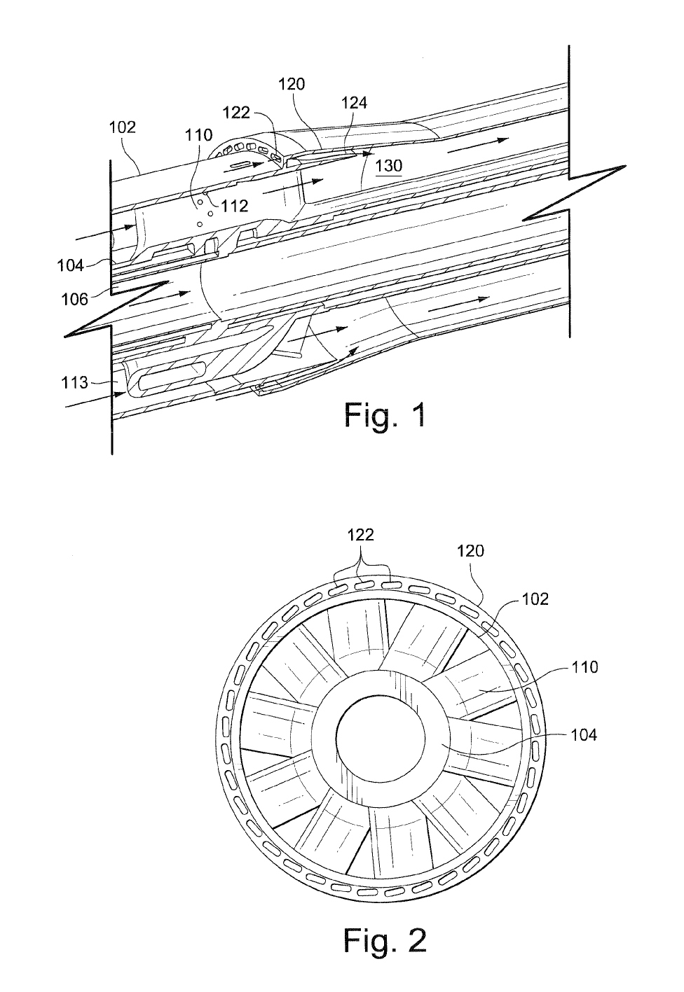

FIG. 1 depicts a downstream portion of a typical fuel injector which can be used in the combustor of a turbine engine. Such a fuel nozzle could include additional structures located upstream of the elements depicted in FIG. 1.

The fuel nozzle includes an outer housing 102 and an inner fuel passageway 104. The fuel nozzle also includes a central fuel passageway 106 which passes down the center of the inner fuel passageway 104. An annular space 113 is formed between the outer surface of the inner fuel passageway 104 and the inner surface of the outer housing 102. Compressed air would flow down through this annular space 113 and mix with fuel before existing the nozzle.

A plurality of swirler vanes 110 extend radially from the outer surface of the inner fuel passage way to a location adjacent the inner surface of the outer housing 102 within the annular space 113. The upstream ends of the swirler vanes extend parallel to the longitudinal axis of the fuel nozzle. However, the downstream ends of the swirler vanes curve to cause the air flowing down the annular space to swirl around the annular space 113 in a rotational fashion.

The swirler vanes 110 are also depicted in the transverse cross sectional view illustrated in FIG. 2. FIG. 2 better illustrates how the downstream ends of the swirler vanes 110 are curved to induce a swirling motion in the air flowing down the length of the nozzle.

A plurality of fuel delivery apertures 112 may be formed in the swirler vanes 110. Fuel would be emitted through the fuel delivery apertures 112 into the flow of air passing down the annular space 113 within the outer housing 102 of the fuel nozzle 100. In addition, or alternatively, fuel could be delivered into the flow of air through different structures. The swirling motion induced by the curved ends of the swirler vanes 110 helps to mix the air and the fuel as it moves down the length of the fuel nozzle.

The fuel nozzle also includes an air admission shroud 120 which includes a plurality of air admission apertures 122 located on the upstream side of the air admission shroud 120. Air passing down the exterior of the outer housing 102 will enter the air admission apertures 122, and the air is then received in an annular passageway 124 within the air admission shroud 120. The air will then be conducted through the annular passageway 124 into an annular space 130 located downstream of the swirler vanes 110.

The air entering the annular space 130 inside the nozzle through the air admission apertures 122 and the annular passageway 124 will then mix with the fuel-air mixture swirling around the annular space 130 downstream of the swirler vanes 110. The fuel-air mixture will then travel to the downstream end 125 of the fuel nozzle where it will exit the fuel nozzle. The fuel-air mixture exiting the fuel nozzle is then ignited within the combustor of the turbine engine.

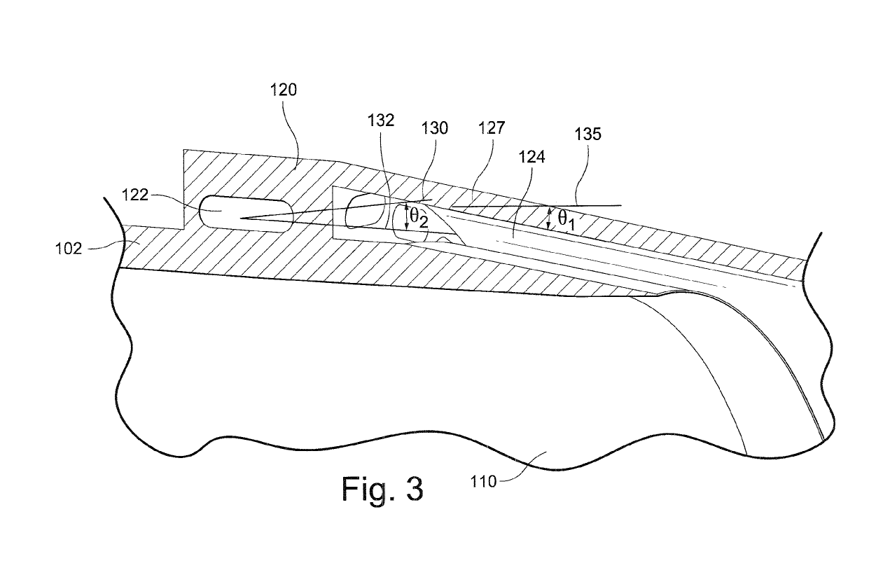

An enlarged cross sectional view of a portion of the air admission shroud on the fuel nozzle is illustrated in FIG. 3. In some embodiments of the air admission shroud, the air admission apertures 122 extend at an angle with respect to a longitudinal axis of the fuel nozzle. As a result, the air passing through the air admission apertures 122 will enter the annular space 124 at an angle, which causes the air within the annular passageway 124 to swirl around the interior in a rotational fashion. This swirling airflow will then enter the annular space 130 downstream of the swirler vanes while it is still swirling in a rotational fashion.

In FIG. 3, a longitudinal axis of one of the air admission apertures 122 is identified with reference numeral 130. A line parallel to the central longitudinal axis of the fuel nozzle is identified with reference numeral 132. The longitudinal axis line 130 and the line 132 parallel to the longitudinal axis of the fuel nozzle are both located in a plane that is parallel to a plane which is tangent to the outer cylindrical surface of the air admission shroud 120 at a location just above the air admission aperture 122. As illustrated in FIG. 3, an angle θ₂ is formed between the longitudinal axis 130 of the air admission aperture 122 and the line 132 parallel to the longitudinal axis of the fuel nozzle.

Then the angle θ₂ is relatively small, the air entering the annular passageway 124 will only swirl a small amount. As the angle θ₂ becomes greater, the air entering the annular passageway 124 will be induced to swirl at a greater rotational velocity around the annular passageway 124.

FIG. 3 also illustrates that the walls of the annular passageway 124 are angled inward with respect to a longitudinal axis of the fuel nozzle. As shown in FIG. 3, the inner surface of the outer wall 127 of the annular passageway 124 forms an angle θ₁ with respect to a line 135 which is parallel to a central longitudinal axis of the fuel nozzle. As a result, the air passing through the annular passageway 124 is directed down into the annular space 130 located downstream of the swirler vanes 110. The slight convergence provided by the angle θ₁ increases the axial of the fuel-air mixture, which helps to avoid problems with flame holding just downstream of the swirler vanes 110.

It is desirable for the air entering the fuel nozzle through the air admission shroud to swirl around the interior of the fuel nozzle in a rotational direction which is opposite to the swirling direction of the air which has passed over the swirler vanes 110. Causing the airflow entering the fuel nozzle through the air admission shroud to swirl in a rotational direction which is opposite to the air-fuel mixture which is already swirling around the interior of the fuel nozzle helps to induce better mixing of the air and the fuel within the nozzle. And the better mixing of the air and fuel leads to a reduction in undesirable combustion byproducts such as NOₓ.

As noted above, FIG. 2 depicts a transverse cross sectional view of the fuel nozzle as seen from an upstream end of the fuel nozzle. Accordingly, air passing down the length of the fuel nozzle will be passing into the plane of the page illustrated in FIG. 2. Because of the way the swirler vanes 110 are curved, air passing across the swirler vanes 110 will swirl in a counterclockwise direction, as viewed from the upstream end of the fuel nozzle.

Accordingly, it is desirable for the air admission apertures 122 of the air admission shroud 120 to induce the air entering through the air admission shroud 120 to swirl in a rotational direction which is clockwise, as seen from the upstream end of the fuel nozzle. Causing the air entering the fuel nozzle through the air admission shroud to swirl in a clockwise direction, which is opposite to the swirl direction induced by the swirl vanes 110, helps to better mix the fuel and air within the fuel nozzle. Also, differences in the longitudinal velocities between the two airstreams creates a shear layer between the two airstreams which also enhances mixing of the air and fuel.

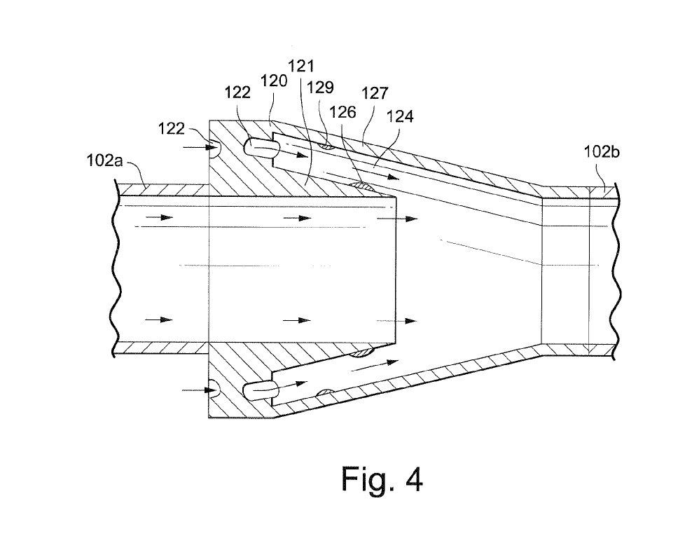

In some embodiments, the air admission shroud can be configured as an insert which is inserted into the length of a fuel nozzle. FIG. 4 illustrates such an embodiment. As shown in FIG. 4, the air admission shroud 120 is actually an insert which is inserted between an upstream end 102a of the fuel nozzle and a downstream end 102b of the fuel nozzle.

As shown in FIG. 4, a plurality of air admission apertures 122 admit air which is passing down the exterior of the upstream end 102a of the fuel nozzle into an annular passageway 124. The air admission holes 122 are angled with respect to a longitudinal axis of the fuel nozzle. As a result, the air entering the annular passageway 124 tends to swirl around the interior of the air admission shroud in a rotational fashion.

In some embodiments, a plurality of turbulence inducing projections 126 may also be located on surfaces of the annular passageway 124. Some turbulence inducing projections 126 can be located on the surface of the inner side 121 of the annular passageway 124. Turbulence inducing projections 129 could also be located on the surface of the exterior wall 127 of the annular passageway 124. The turbulence induced by the turbulence inducting projections would further help to mix the air and the fuel within the nozzle.

In some embodiments, the turbulence inducing projections would be arranged in a concentric ring around one or both of the walls of the annular passageway 124. In other embodiments, the turbulence inducing projections could be located in other types of patterns on the walls of the annular passageway. The turbulence inducing projections may also be located in a pattern that helps to preserve the swirling motion of the air passing through the annular passageway 124. Also, the turbulence inducing projections may also have a shape that helps to preserve the swirling motion of the air passing through the annular passageway 124.

The provision of the air admission apertures 122 can also have a beneficial effect on combustor dynamics. The space within head end of the combustor can act as an absorption volume. By selectively varying the number, position and aperture size of the air admission apertures 122, one can cause selected undesirable vibration frequencies to be absorbed. Varying the number, position and aperture size of the air admission apertures 122, allows one to target certain specific frequencies for absorption.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A fuel nozzle for a combustor of a turbine engine, comprising:
an outer housing;
an air admission shroud located at an intermediate point along a length of the outer housing, wherein the air admission shroud includes a plurality of air admission apertures that allow air passing along an exterior of the outer housing to enter an interior of the outer housing.

2. The fuel nozzle of claim 1, wherein a plurality of swirler vanes are located inside the outer housing, and wherein the plurality of swirler vanes cause air passing down the interior of the outer housing to swirl in a first rotational direction around the interior of the outer housing.

3. The fuel nozzle of claim 2, wherein the plurality of air admission apertures cause air entering the interior of the outer housing through the plurality of air admission apertures to swirl around the interior of the outer housing.

4. The fuel nozzle of claim 2, wherein the plurality of air admission apertures cause air entering the interior of the outer housing through the plurality of air admission apertures to swirl around the interior of the outer housing in a second rotational direction that is opposite to the first rotational direction.

5. The fuel nozzle of claim 4, wherein a longitudinal axis of each air admission aperture extends at an angle with respect to a longitudinal axis of the fuel nozzle within a plane that is approximately tangent to an exterior cylindrical surface of the air admission shroud at a location immediately adjacent to the air admission aperture.

6. The fuel nozzle of claim 5, wherein the angle is between about 10° and about 60°.

7. The fuel nozzle of claim 5, wherein the angle is about 45°.

8. The fuel nozzle of claim 1, wherein the plurality of air admission apertures cause air entering the interior of the outer housing through the plurality of air admission apertures to swirl in a rotational direction around the interior of the outer housing.

9. The fuel nozzle of claim 8, wherein a longitudinal axis of each air admission aperture extends at an angle with respect to a longitudinal axis of the fuel nozzle within a plane that is approximately tangent to an exterior cylindrical surface of the air admission shroud at a location immediately adjacent to the air admission aperture.

10. The fuel nozzle of claim 9, wherein the angle is between about 10° and about 60°.

11. The fuel nozzle of claim 9, wherein the angle is about 45°.

12. The fuel nozzle of claim 1, wherein the air admission shroud includes an annular passageway that conducts air passing through the plurality of air admission apertures to the interior of the outer housing.

13. The fuel nozzle of claim 12, wherein turbulence inducing projections are formed on at least one surface of the annular passageway.

14. The fuel nozzle of claim 13, wherein the turbulence inducing projections are located on an inner wall of the annular passageway.

15. The fuel nozzle of claim 14, wherein the turbulence inducing projections extend around a circumference of the annular passageway.

16. A fuel nozzle for a combustor of a turbine engine, comprising:
an outer housing;
an inner fuel passageway located at approximately the center of the outer housing;
a plurality of swirler vanes that are located in an annular space between an outer surface of the inner fuel passageway and an inner surface of the outer housing, wherein the plurality of swirler vanes cause air passing down the annular space to swirl in a first rotational direction around the annular space; and
an air admission shroud located at an intermediate point along a length of the outer housing, wherein the air admission shroud includes a plurality of air admission apertures that allow air passing along an exterior of the outer housing to enter the annular space at a location downstream of the swirler vanes.

17. The fuel nozzle of claim 16, wherein a longitudinal axis of each air admission aperture extends at an angle with respect to a longitudinal axis of the fuel nozzle within a plane that is tangent to an exterior surface of the air admission shroud at a position immediately adjacent to the air admission aperture.

18. The fuel nozzle of claim 16, wherein respective longitudinal axes of the plurality of air admission apertures are arranged such that air entering the annular space through the plurality of air admission apertures swirls in a rotational direction around the annular space.

19. The fuel nozzle of claim 16, wherein respective longitudinal axes of the plurality of air admission apertures are arranged such that air entering the annular space through the plurality of air admission apertures swirls in a second rotational direction around the annular space, the second rotational direction being opposite to the first rotational direction.

20. The fuel nozzle of claim 16, wherein a longitudinal axis of each air admission aperture extends at an angle of about 45° with respect to a longitudinal axis of the fuel nozzle within a plane that is tangent to an exterior surface of the air admission shroud at a position immediately adjacent to the air admission aperture.
